(19) United States
(12) Patent Application Publication
(10) Pub. No.: US 2025/0186938 A1
(43) Pub. Date: Jun. 12, 2025

(54) POROUS MEDIUM AND GAS-LIQUID SYSTEM CONTAINING THE SAME

(71) Applicant: INDUSTRIAL CLIMATE SOLUTIONS INC., Calgary (CA)

(72) Inventors: Hossein Khorshidian, Calgary (CA); Roy J. Pellegrin, JR., Idaho Falls, ID (US); Albert J. Commodore, Calgary (CA); William Hargrove, Easton, MD (US)

(21) Appl. No.: 18/532,349

(22) Filed: Dec. 7, 2023

(51) Int. Cl. B01D 53/18; B01D 53/14; B01D 53/62; B01D 53/78

(52) U.S. Cl. CPC B01D 53/18; B01D 53/1475; B01D 53/62; B01D 53/78; B01D 2257/504

(57) ABSTRACT

A porous medium for a gas-liquid system includes a screen having a top surface, an opposite bottom surface, and a peripheral surface, the screen having a porous wall forming alternating ridges and valleys connected by ridge sidewalls extending from the bottom surface of the screen to the top surface of the screen, wherein the porous wall includes more than one porous layer, and each pair of the adjacent porous layers define a microchannel therebetween. The porous medium or a module thereof can be used in a gas-liquid system. The porous medium or a module thereof can also be used for absorbing a selected component from a gas.

### BACKGROUND

Gas absorption is an operation which involves transfer of materials from one phase to another. Gas absorption is usually carried out in vertical and cylindrical columns or towers such as absorbers, where gas and liquid phases are brought into contact with each other in porous media so that components of the gas phase can dissolve into or otherwise transfer to the liquid phase due to their interaction.

The gas and liquid phases can interact via co-current flow or counter-current flow in the absorbers. In co-current gas absorption, the gas and liquid are both introduced from the same side of the column and flow downward due to gravity and imposed pressure gradient. In the counter-current flow, the gas is introduced from the bottom while the liquid is introduced from the top, so that the liquid phase falls down through the absorber due to gravity, and the gas phase moves up against the downward flow of the liquid.

The co-current absorption columns normally have smaller footprints compared to counter-current columns. However, porous media utilized in the co-current columns may result in higher pressure drops associated with the flow of multiphase fluids. Accordingly, there is a continuing need for porous media to reduce the overall pressure drop. It would be a further advantage if such porous media can reduce pressure drops while maintaining the capillarity and hydraulic continuity.

### SUMMARY

A porous medium for a gas-liquid system comprises: a screen having a top surface, an opposite bottom surface, and a peripheral surface, the screen comprising a porous wall forming alternating ridges and valleys connected by ridge sidewalls extending from the bottom surface of the screen to the top surface of the screen, wherein the porous wall comprises more than one porous layer, and each pair of the adjacent porous layers define a microchannel therebetween.

A gas-liquid system comprises: a gas inlet and a liquid inlet arranged to allow a gas and a liquid to flow into the system; an absorption or reaction section comprising a plurality of porous media arranged in a horizontal direction, a vertical direction, or a combination thereof; a gas outlet; and a liquid outlet, wherein at least one of the plurality of the porous media is the above-described porous medium.

A method of absorbing a selected component from a gas includes: introducing the gas and a liquid into a gas-liquid system; allowing the gas and the liquid to flow through an absorption or reaction section of the gas-liquid system, wherein at least one of the plurality of the porous media is the above-described porous medium.

### BRIEF DESCRIPTION OF THE DRAWINGS

The following descriptions should not be considered limiting in any way. With reference to the accompanying drawings, like elements are numbered alike:

FIG. 1 illustrates an embodiment of a porous medium comprising a screen having a corrugated pattern formed from a porous wall with multiple porous layers;

FIG. 2 is a cross-sectional view of a porous medium comprising a screen having a corrugated pattern formed from a a porous wall with multiple porous layers;

FIG. 3 illustrates a zigzag pattern of a screen in a porous medium;

FIG. 4 is a cross-sectional view of two ridges and a valley of a screen in a porous medium;

FIG. 5A illustrates a ridge with parallel sidewalls, FIG. 5B illustrates a ridge with sidewalls having a negative wall angle, and FIG. 5C illustrates a ridge with sidewalls with a positive wall angle;

FIG. 6 is a side view of a portion of a screen formed of a porous wall with multiple porous layers;

FIG. 7 is another side view of a portion of a screen formed of a porous wall with multiple porous layers;

FIG. 8 illustrates an assembly comprising a plurality of porous media arranged in a horizontal (lateral) direction;

FIG. 9 illustrates an assembly comprising a plurality of porous media arranged in a vertical direction;

FIG. 10 is a partial cut-away view of an assembly comprising a plurality of porous media arranged in a vertical direction; and

FIG. 11 illustrates a gas-liquid system including a plurality of porous media in an absorption or reaction section of the system.

### DETAILED DESCRIPTION

Disclosed is a porous medium that can maximize the flow area (opening) to flow of fluids thus minimizing the pressure drops resulted from fluids' viscosity and flow inertia while maintaining the hydraulic continuity of the liquid phase and the capillarity associated with the fluids' interface at a particular desired range. The porous medium can also be tailored to obtain pulsating or bubbly flow regimes for maximizing gas-liquid contact and increasing the absorption rate and product throughput, thereby lowering the energy intensity of the gas-liquid systems such as absorbers, and reducing the operational cost and process footprint.

The porous medium can also be more resistant to accumulation of the precipitated solid materials compared to commercially available medium, due to elevated rate of flow and pulsating nature in the co-current flow applications. In addition, the porous medium can prevent gas channeling which can negatively affect the efficiency of the gas-liquid systems. The porous medium can also be easily installed and maintained.

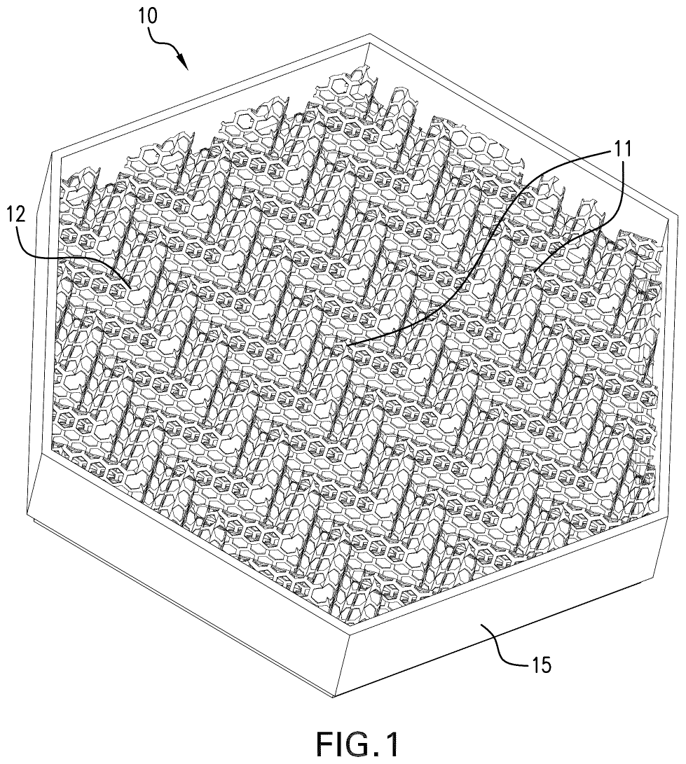

Referring to FIGS. 1-4, a porous medium (10) comprises a corrugated screen (12) having a top surface (11), an opposite bottom surface (18), and a peripheral surface (19), which can extend from an edge of the top surface (11) to an edge of the bottom surface (18). The screen (12) comprises a porous wall (17) forming alternating ridges (20) and valleys (28) connected by ridge sidewalls (27), the ridge sidewalls (27) extending from the bottom surface (18) of the screen to the top surface (11) of the screen. The ridges (20) can be arranged horizontally in a zigzag pattern along the top surface (11) of the screen to increase the overall flow area.

The porous wall has a plurality of openings or pores. The geometry of the pores is not particularly limited and can be any shape such as hexagonal, triangular, square, circular, octagonal, or the like. The pores can be present in the ridge sidewalls and valleys, and optionally ridges as well. The average pore area can be about 0.0002 square inch to about 0.2 square inch, or preferably about 0.004 square inch to about 0.02 square inch. The average pore area can be determined by the fluid properties (e.g., viscosity, surface tension and density), their flowrates, operational conditions (e.g., target pressure drop and rate of absorption), and process plant footprint. A total open area formed by the pores can be about 40% to about 90%, preferably about 60% to about 70%, based on a surface area of the porous wall. In addition, the openings/pores in the porous medium can have an average size of about 1/64 inch to about 0.375 inch. As used herein, the size of a pore refers to the largest diameter of the pore.

In an aspect, the pores are hexagonal with the sizes from about 1/64 inch to about ¼ inch, preferably about 1/32 inch to about ⅛ inch, and the pores can have a center-to-center distance of about 1/16 inch to about ¾ inch or about ⅛ inch to about ⅜ inch depending on the pore sizes.

The porous walls (17) have multiple porous layers spaced apart to trap or hold liquid (or gas). A distance between the adjacent porous layers can be about 1% to about 50% of the average pore size in the porous medium. In particular, the distance between the adjacent porous layers can be about 1/64 inch to about ⅛ inch, preferably about 1/32 inch to about 1/16 inch. The space between the adjacent porous layers can create a path of fine capillaries or a microchannel, which can hold liquid and establish a strong hydraulic continuity. Hydraulic continuity is explained, for example, in Journal of Petroleum Science and Engineering, 165 (2018), 375-387 by Khorshidian et al. The number of the porous layers in a porous wall can vary from two to five, two to four, two to three, or two.

The size and geometry of the pores in different porous layers can be the same or different. In addition, the pores in different porous layers can be aligned or overlapping. As used herein, overlap is defined by the ratio of the total open area and the maximum possible opening. One hundred percent overlap in a multiple-layer medium is when the openings are completely aligned (concentric) and the flow area is maximized. A lower percentage of overlap is when the openings are misaligned and the open flow area in the direction of flow is a fraction of the maximum opening. For example, the overlap of the pores in the adjacent porous layers can be 0% to about 50%, about 30% to about 100%, about 40% to about 80%, about 40% to about 70% or about 50%.

In an aspect, the pores on an outer porous layer are larger than the pores in an inner porous layer. For example, the pores in the outer porous layer can have a larger average pore area than the pores in the inner porous layer. The arrangement facilitates the exposure of the space between two porous layers to the flow of fluids. And the exposure contributes to a better hydraulic continuity and formation of gas bubbles in the co-current flow of gas and liquid. In an embodiment, the number of layers is two and the overlap between the pores of the two layers is about 30% to about 70%, about 40% to about 60% or about 50%. As an example, the layers are identical, and the pores in the adjacent layers are fully aligned.

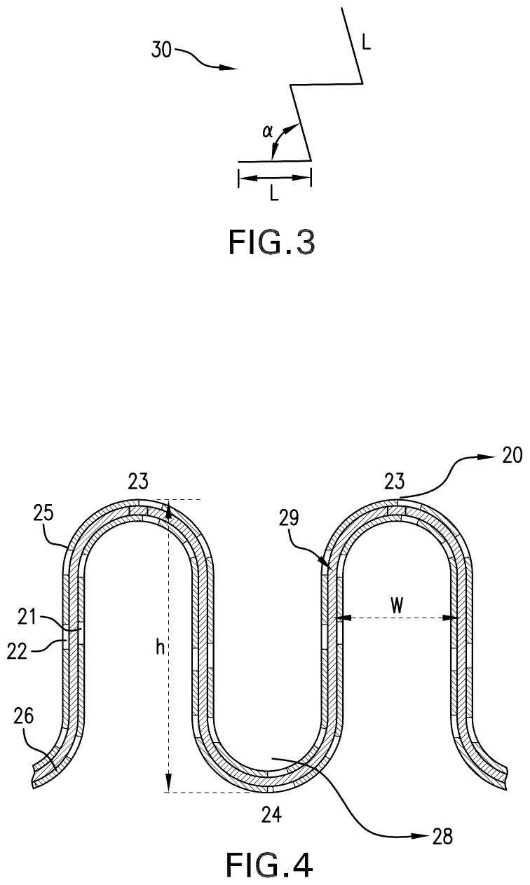

As shown in FIG. 3 and FIG. 4, the porous wall can form alternating ridges (20) and valleys (28), and the ridges (20) can extend horizontally to form a zigzag pattern (30) along the top surface of the screen. The zigzag pattern (30) can have a zigzag angle (α) of about 30° to about 60°, preferably about 35° to about 55°, more preferably about 40° to about 50°, or about 45°. The length (L) of each zigzagged segment can be from about 0.4 inch to about 0.9 inch, preferably about 0.5 inch to about 0.75 inch. The zigzag pattern can increase the permeability of a packed column providing a larger flow area (more openings).

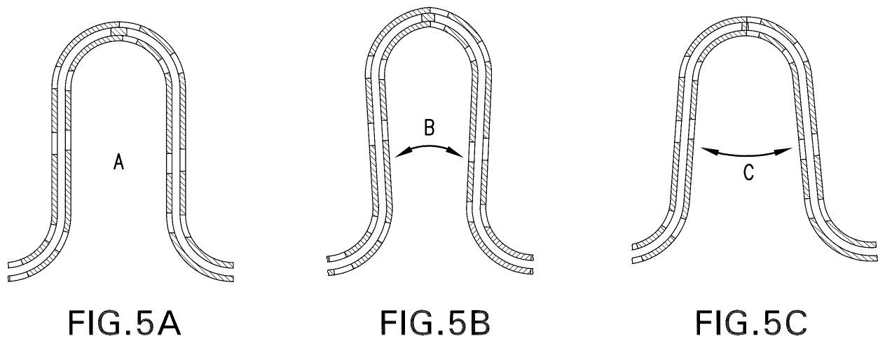

The repeating structures formed by the ridges and the ridge sidewalls can have a rectangular cross-section with or without rounded corners. The ridges can have a ridge height (h) from the bottom (24) to the top (23) and a ridge width (w) from a center of a ridge sidewall to a center of another ridge sidewall, and a ratio of the ridge height (h) to the ridge width (w) can be about 0.5 to about 6, about 1 to about 5, or about 1.5 to about 2. The ridge height (h) can be about 0.1 inch to about 0.6 inch, about 0.2 inch to about 0.5 inch, or about 0.3 inch to about 0.4 inch, and the ridge width (w) can be about 0.05 inch to about 0.5 inch or about 0.08 inch to about 0.2 inch. As shown in FIGS. 5A-5C, the ridge sidewalls can be parallel (A), or have a bulged shape (negative wall angle, B), or a diverging shape (positive wall angle, C). The wall angle influences the pressure drop, flow regime, and manufacturing process. Preferably, the ridge sidewalls can have a wall angle relative to a vertical axis of about ±30°, about ±20°, or about ±10°. The ridge sidewalls with a negative wall angle can result in a bubbly flow regime depending on the rate of gas and liquid flow.

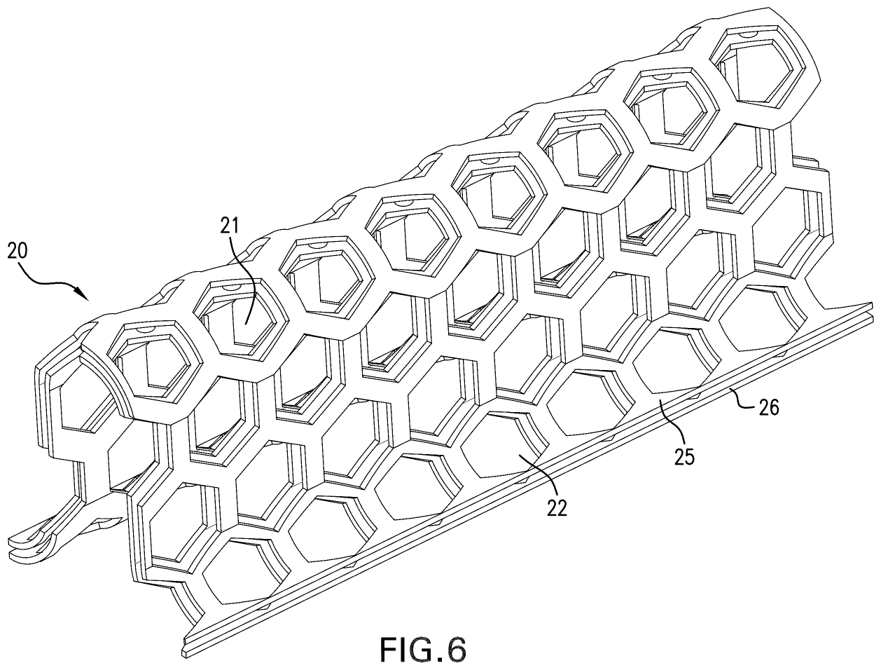

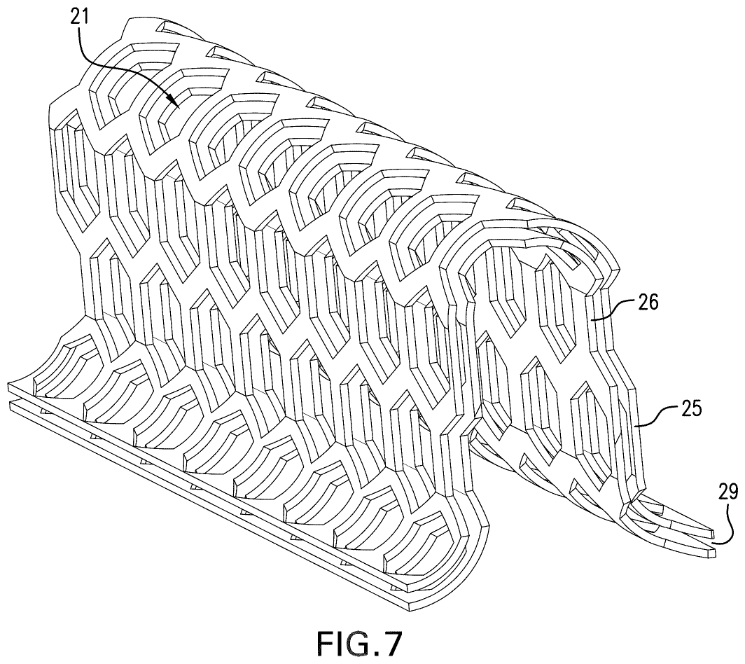

FIGS. 6 and 7 illustrate a portion of a screen including a ridge formed from a porous wall having an inner porous layer (26) and an outer porous layer (25), where the two layers have aligned hexagonal pores (21, 22). The pores (21) in the inner layer (26) can be smaller than the pores (22) in the outer layer (25). The two porous layers form a path of fine capillaries or a microchannel (29) that can hold liquid and establish a strong hydraulic continuity.

The screen can be made from metals, plastics, composites, or any other suitable materials by pressing, thermal/compression molding, sintering, and/or cutting.

The porous medium (10) can comprise a frame (15) that holds the corrugated screen and seals the peripheral surface (19) of the screen (12). The sealing of the peripheral surface prevents bulk flows from the peripheral area during use, and allows the porous medium to be installed in a module or a gas-liquid system without leakage in the boundaries. The frame also makes it quick and simple for installation, dismantling, and in-situ cleaning of the porous medium, thus minimizing the operation cost.

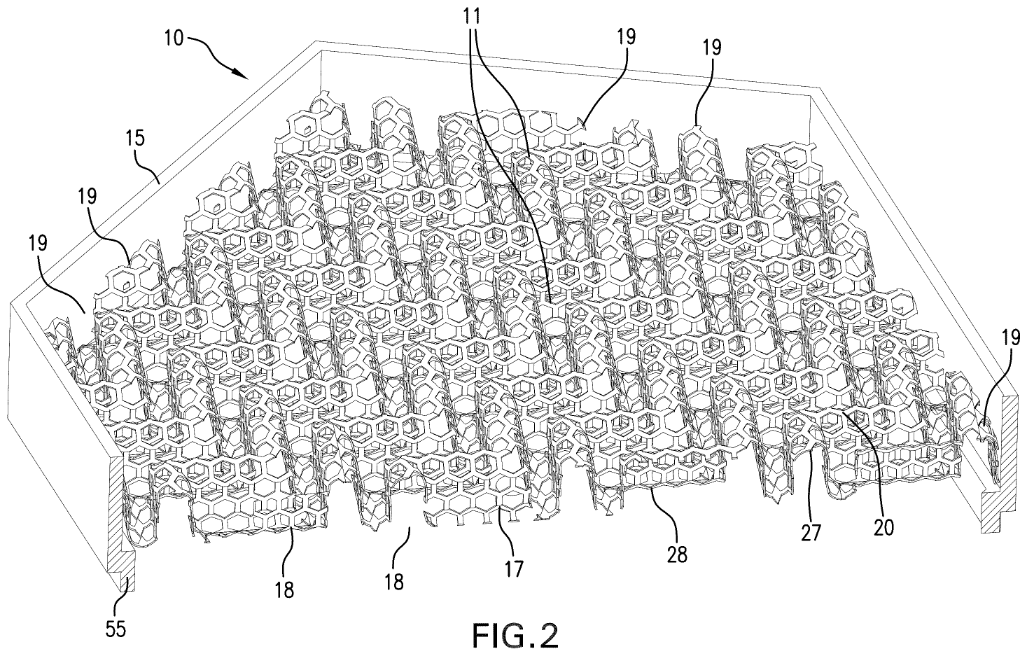

In FIGS. 1 and 2, a frame having a hexagonal geometry is shown. However, it is appreciated that the frame can have other geometries such as circular or other shapes depending on the application. The frame can have an edge (55) at the bottom to hold the screen in place, and to facilitate the stacking of the porous medium.

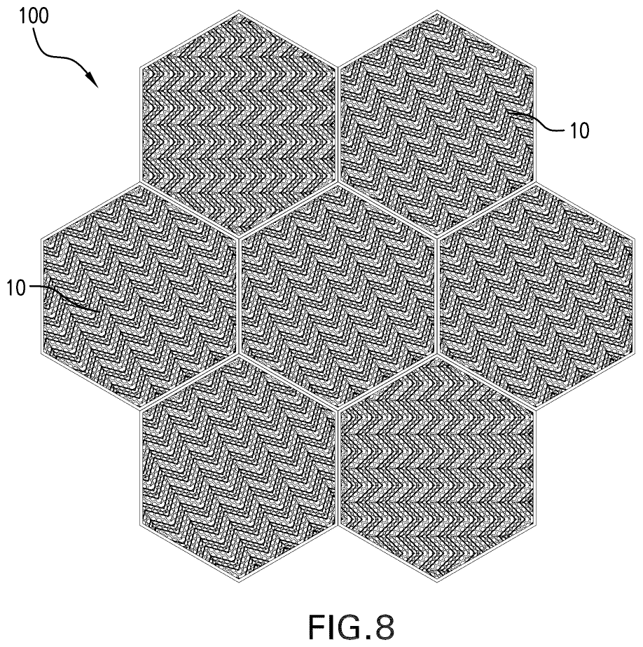

The porous media can be stacked in a vertical direction, a horizontal direction, or a combination thereof to form an assembly. FIG. 8 illustrates an assembly (100) comprising a plurality of porous media (10) stacked in a horizontal (lateral) direction.

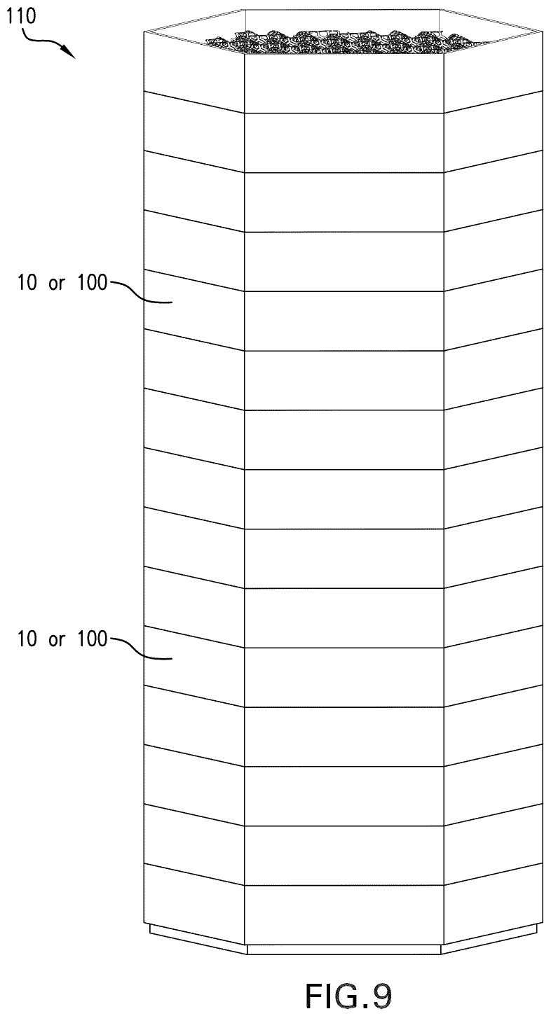

FIG. 9 illustrates an assembly (110) comprising a plurality of porous media (10) or horizontally patterned assemblies (100) stacked in a vertical pattern. In vertical stacking, the bottom of the upper porous medium can be placed directly on top of the lower porous medium. The number of the porous media in the vertical patterning depends on the height of the gas-liquid system, and can be determined based on the targeted gas and liquid loading. An assembly can also be referred as a module. As an example, a module can contain 10 to 50 porous media.

The porous media can be stacked vertically (without leakage in boundaries of the assembly) at a particular distance to promote the desirable flow regimes and absorption rate under optimized pressure drop conditions. The spacing depends on the stability of pulsation and pressure drop target, column dimensions, absorption, or reaction rate. In an aspect of the invention, the spacing between the adjacent vertically stacked screens (center to center) can be from about ⅛ inch to about 1 inch, about 0.3 inch to about 1 inch, about 0.25 inch to about 0.5 inch, or about 0.5 inch to about 0.75. The spacing can be maintained by the frame of the porous media.

The type of screens or porous media stacked in a module can be the same or different. In an absorption column, different modules containing various types of porous medium can be stacked to control the flow regime, pressure drop, mass transfer and absorption rate depending on the operational conditions and type of fluids flowing through the column.

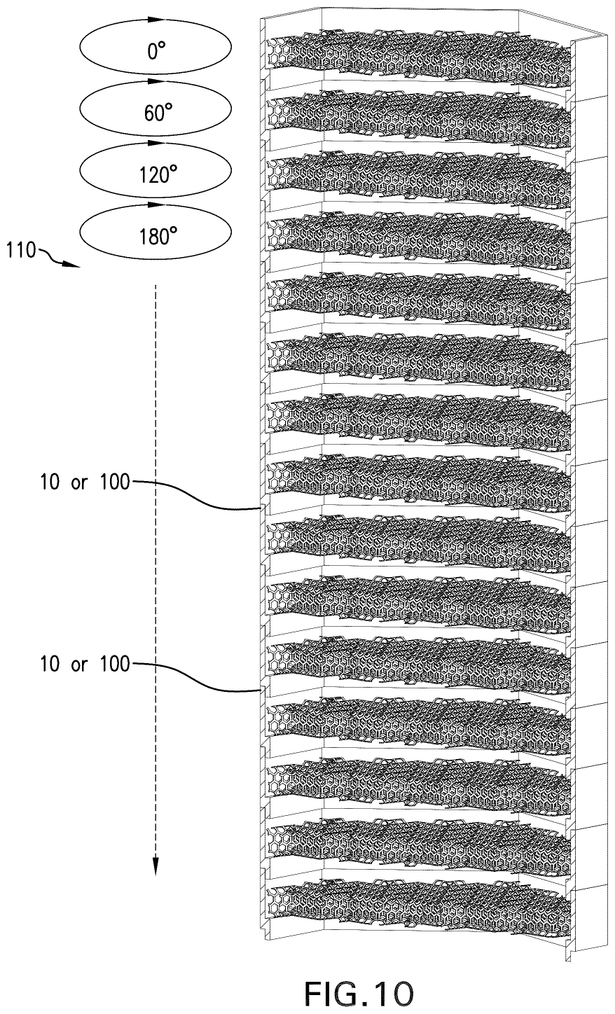

Referring to FIG. 10, the porous media can be rotated when assembled so that the adjacent porous media are not aligned. In an aspect, the adjacent porous media are offset or rotated so that their axes of rotation are offset between about 45° and about 90°, about 50° to about 80°, or about 50° to about 70°, or about or about 60° C. The rotation of the porous media can facilitate the even distribution of a liquid from one screen to another screen.

The porous media or a module of the porous media thereof can be used in a gas-liquid system such as an absorber or a reactor. The gas-liquid system can be a co-current flow system or a counter-current flow system, preferably a co-current flow system. Advantageously, the porous media having the ridge/valley structure formed from a multilayer porous wall can be tuned to provide the desired relative permeability for the gas and liquid phases to maximize the performance of the co-current flow system.

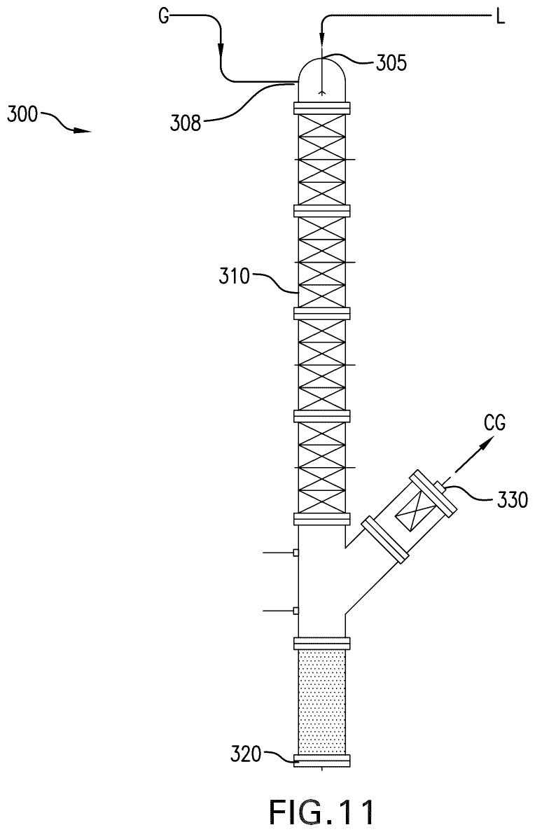

Referring to FIG. 11, a gas-liquid system (300) comprises a gas inlet (308) and a liquid inlet (305) arranged to allow a gas (G) and a liquid (L) to flow into the system; an absorption or reaction section (310) which comprises a plurality of the porous media as described herein; a gas outlet (330) and a liquid outlet (320). The system can have a cylindrical shape, for example the system can be an absorber column. For a gas-liquid co-current flow system, the gas inlet and the liquid inlet can be arranged to allow the gas and the liquid to flow co-currently (e.g. downwardly) in the system. The porous media can be positioned such that the zigzag pattern, if present, is extended in a direction that is perpendicular to a flow direction of the gas and the liquid introduced into the system.

The plurality of the porous media can be stacked to form an assembly or module as described herein. For example, the system can comprise a plurality of modules, where each module extends horizontally or transversely from side wall to side wall, and across the vertical cross-section of the system such as an absorber column or a reaction chamber. The gas-liquid system can include at least one module. The number of the modules in the horizontal patterning depends on the system diameter and the size of each module. The number of the modules in the vertical patterning depends on the height of the system and the size of the module as well. The diameter and height of the system can be determined based on the targeted gas and liquid loading.

The gas-liquid system can be used for CO₂ capture or gas purification. A method of absorbing a selected component from a gas comprises introducing a gas and a liquid into a gas-liquid system, allowing the gas and the liquid to flow through an absorption or reaction section of the system, where the absorption or reaction section comprises a plurality of the porous media as described herein. In the absorption or the reaction section, the liquid and the gas phases intermix at the porous media, and components in the gas phase such as CO₂ or impurities can be transferred to the liquid phase via physical absorption, chemical absorption, or a combination thereof. Preferably, the system includes a vertical column, and both the liquid and gas can flow co-currently (i.e. downwardly) through the porous media.

Trickle flow is the most common flow regime encountered in industrial applications. The porous medium described herein allows for the generation of a more favorable flow regime, pulsing flow, for the advantages in terms of an increase in mass and heat transfer rates, complete porous media wetting and a decrease in axial dispersion and gas channeling compared to the trickle flow regime.

Virla et al. describe corrugated screening packing operating in a pulse flow regime in Ind. Eng. Chem. Res. 2020, 59, 25, 11767-11776. In the gas-liquid system disclosed herein, pulses can also form spontaneously from the aero-hydrodynamics through the corrugated screens having microchannels. In the module(s) of the gas-liquid system, a stream of bubbles can form froth matrices that are projected from the bottom of the ridges and valleys of one porous medium (first porous medium) to the top of another porous medium (second porous medium). Bubbles streaming from the ridges and valleys of the first porous medium intersect with ridges and valleys of second porous medium. The bubbles are reformed as the liquid and gas pass through the second porous medium. Local concentration variances of bubble formation cause anisotropic flows of bubbles along the linear axis of the ridges. This anisotropic flow introduces instability into the flow field that evolves into the liquid pulsing phenomena. As more liquid phase is held up in the ridges, more gas flow through the screen is blocked, increasing differential pressure across the porous medium. At a point of equilibrium, a localized pulse of froth matrices separates from a portion of a ridge or group of ridges. The pulse is projected across localized sections of several ridges that are offset about 50 to about 70 degrees or about 60 degrees of the next downstream porous medium as illustrated in FIG. 10.

When the localized pulse from several ridges impacts the ridges in the next downstream screen, froth and bubbles held up in the ridges of the downstream element cascades from the affected ridges, adding to the growing pulse. As partial pulses cascade and grow through the first set of the porous media, the collective rotation of the ridges reaches 360 degrees, and the mass of the pulse increases enough to form a plug pulse of froth that covers the entire area of the medium. The plug pulse can prevent gas channeling around the liquid phase over a wide range of gas and liquid flow rates.

Due to flow resistance of the liquid through the screens, the solvent pulses travel at a lower velocity compared to the gas through the absorption section of the gals-liquid co-current flow system. Depending on the pulse generation rate, flow resistance, gas velocity, and height of the absorption section of the system, a defined volume of gas passes through several pulses as the gas and pulses advance through the absorption section.

The geometry of the porous media can also create bubbly flow regimes (non-wetting phase trapped in the wetting phase) via adjusting magnitudes and ratio of gas/liquid flow, and the liquid phase saturation. The bubbly flow regime can occur at higher gas flow rates, for example a gas to liquid flow ratio of about 4 to about 16, preferably about 8 to about 12. In this regime, the liquid pulses vanish, and the multiphase flow is mostly seen as gas bubbles surrounded by liquid membrane. Ridges with negative wall angle have more tendency towards bubbly flow regime compared to pulsating flow regime. A bubbly flow can provide superior regime compared with pulsating and trickle flow in terms of gas-liquid interaction in an absorption column or reaction chamber.

The porous media can operate with precipitating system resulted from gas-liquid reactions without fouling. The high interface renewal rate and the large intricate interfacial area of the porous media can maximize mass transfer, which can in turn minimize column height and transit time through the porous media. In addition, shear forces generated by the hydrodynamics can overcome the forces of molecular attraction, which when combined with the short transit time, can inhibit precipitants from growing large enough to block the porous media openings. Meanwhile, the momentum of the liquid pulses and gas and liquid flows can transport the precipitants out of the absorber column or reaction chambers.

Other than absorber columns, the porous media can be used for a wide range of industrial applications such as reaction chambers at lower cost, improved performance, faster delivery that meet high-volume demands. The porous media can also be easily installed and/or maintained.

Set forth below are some aspects of the foregoing disclosure:

Aspect 1. A porous medium for a gas-liquid system comprising: a screen having a top surface, an opposite bottom surface, and a peripheral surface, the screen comprising a porous wall forming alternating ridges and valleys connected by ridge sidewalls extending from the bottom surface of the screen to the top surface of the screen, wherein the porous wall comprises more than one porous layer, and each pair of the adjacent porous layers define a microchannel therebetween.

Aspect 2. The porous medium as in any prior aspect, further comprising a frame sealing the peripheral surface of the screen.

Aspect 3. The porous medium as in any prior aspect, wherein the ridges are arranged horizontally in a zigzag pattern along the top surface of the screen.

Aspect 4. The porous medium as in any prior aspect, wherein the zigzag pattern has a zigzag angle of about 30° to about 60°, a zigzag segment length of about 0.4 inch to about 0.9 inch, or a combination thereof.

Aspect 5. The porous medium as in any prior aspect, wherein a distance between the adjacent porous layers is about 1% to about 50% of an average pore size in the porous medium.

Aspect 6. The porous medium as in any prior aspect, wherein an overlap of the pores in the adjacent porous layers is 0% to about 50%.

Aspect 7. A porous medium assembly comprising a plurality of the porous media as in any prior aspect arranged in a horizontal direction, a vertical direction, or a combination thereof.

Aspect 8. A gas-liquid system comprising: a gas inlet and a liquid inlet arranged to allow a gas and a liquid to flow into the system; an absorption or reaction section comprising a plurality of porous media arranged in a horizontal direction, a vertical direction, or a combination thereof; a gas outlet; and a liquid outlet, wherein at least one of the plurality of the porous media is a porous medium as in any of Aspects 1 to 6.

Aspect 8. The gas-liquid system as in any prior aspect, wherein the at least one of the plurality of the porous media is positioned such that the zigzag pattern is extended in a direction that is perpendicular to a flow direction of the gas and the liquid in the gas-liquid flow system.

Aspect 9. The gas-liquid system as in any prior aspect, wherein the adjacent porous media are offset or rotated so that their axes of rotation are offset between about 45° and about 90°.

Aspect 10. The gas-liquid system as in any prior aspect, wherein pores are present in the valleys and the ridge sidewalls.

Aspect 11. The gas-liquid system as in any prior aspect, wherein the gas-liquid system is a co-current flow system.

Aspect 12. A method of absorbing a selected component from a gas, the method comprising: introducing the gas and a liquid into a gas-liquid system; allowing the gas and the liquid to flow through an absorption or reaction section of the gas-liquid system, wherein at least one of the plurality of the porous media is a porous medium as in any of Aspects 1 to 6.

Aspect 13. The method as in any prior aspect, wherein the method further comprises establishing a hydraulic continuity of the liquid via the microchannel.

Aspect 14. The method as in any prior aspect, further comprising generating a bubbly flow regime when the gas and the liquid flow through the plurality of the porous media.

Aspect 15. The method as in any prior aspect, wherein a gas to liquid flow ratio in the absorption or reaction section of the gas-liquid system is about 4 to about 16.

Aspect 16. The method as in any prior aspect, further comprising generating a pulsating flow regime when the gas and the liquid flow through the plurality of the porous media.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

While the invention has been described with reference to an exemplary embodiment or embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A porous medium for a gas-liquid system comprising:
a screen having a top surface, an opposite bottom surface, and a peripheral surface, the screen comprising a porous wall forming alternating ridges and valleys connected by ridge sidewalls extending from the bottom surface of the screen to the top surface of the screen,
wherein the porous wall comprises more than one porous layer, and each pair of the adjacent porous layers define a microchannel therebetween.

2. The porous medium of claim 1, further comprising a frame sealing the peripheral surface of the screen.

3. The porous medium of claim 1, wherein the ridges are arranged horizontally in a zigzag pattern along the top surface of the screen.

4. The porous medium of claim 3, wherein the zigzag pattern has a zigzag angle of about 30° to about 60°, a zigzag segment length of about 0.4 inch to about 0.9 inch, or a combination thereof.

5. The porous medium of claim 1, wherein a distance between the adjacent porous layers is about 1% to about 50% of an average pore size in the porous medium.

6. The porous medium of claim 1, wherein an overlap of the pores in the adjacent porous layers is 0% to about 50%.

7. A porous medium assembly comprising a plurality of the porous media of claim 1 arranged in a horizontal direction, a vertical direction, or a combination thereof.

8. A gas-liquid system comprising:
a gas inlet and a liquid inlet arranged to allow a gas and a liquid to flow into the system;
an absorption or reaction section comprising a plurality of porous media arranged in a horizontal direction, a vertical direction, or a combination thereof;
a gas outlet; and
a liquid outlet,
wherein at least one of the plurality of the porous media comprises:
a screen having a top surface, an opposite bottom surface, and a peripheral surface, the screen comprising a porous wall forming alternating ridges and valleys connected by ridge sidewalls extending from the bottom surface to the top surface of the screen, wherein the porous wall comprises more than one porous layer, and each pair of the adjacent porous layers define a microchannel therebetween.

9. The gas-liquid system of claim 8, wherein the plurality of the porous media are arranged in a horizontal direction, a vertical direction, or a combination thereof.

10. The gas-liquid system of claim 8, wherein the at least one of the plurality of the porous media further comprises a frame sealing the peripheral surface of the screen.

11. The gas-liquid system of claim 8, wherein the ridges in the at least one of the plurality of the porous media are arranged horizontally in a zigzag pattern along the top surface of the screen, and the at least one of the plurality of the porous media is positioned such that the zigzag pattern is extended in a direction that is perpendicular to a flow direction of the gas and the liquid in the gas-liquid flow system.

12. The gas-liquid of claim 8, wherein the adjacent porous media are offset or rotated so that their axes of rotation are offset between about 45° and about 90°.

13. The gas-liquid system of claim 8, wherein a distance between the adjacent porous layers is about 1% to about 50% of an average pore size in the porous medium.

14. The gas-liquid system of claim 8, wherein an overlap of the pores in the adjacent porous layers is about 0% to about 50%.

15. The gas-liquid system of claim 8, wherein pores are present in the valleys and the ridge sidewalls.

16. The gas-liquid system of claim 8, wherein the gas-liquid system is a co-current flow system.

17. A method of absorbing a selected component from a gas, the method comprising:
introducing the gas and a liquid into a gas-liquid system;
allowing the gas and the liquid to flow through an absorption or reaction section of the gas-liquid system,
wherein the absorption or reaction section comprises a plurality of porous media arranged in a horizontal direction, a vertical direction, or a combination thereof; and
transferring the selected component from the gas to the liquid in the absorption or reaction section of the gas-liquid flow system,
wherein at least one of the plurality of the porous media comprises:
a screen having a top surface, an opposite bottom surface, and a peripheral surface, the screen comprising a porous wall forming alternating ridges and valleys connected by ridge sidewalls extending from the bottom surface to the top surface of the screen, wherein the porous wall comprises more than one porous layer, and each pair of the adjacent porous layers define a microchannel therebetween.

18. The method of claim 17, wherein the method further comprises establishing a hydraulic continuity of the liquid via the microchannel.

19. The method of claim 17, further comprising generating a bubbly flow regime when the gas and the liquid flow through the plurality of the porous media.

20. The method of claim 17, wherein a gas to liquid flow ratio in the absorption or reaction section of the gas-liquid system is about 4 to about 16.

21. The method of claim 17, further comprising generating a pulsating flow regime when the gas and the liquid flow through the plurality of the porous media.
